(19) United States
(12) Patent Application Publication
(10) Pub. No.: US 2026/0189098 A1
(43) Pub. Date: Jul. 2, 2026

(54) COMPRESSION SEALING FOR STATOR COOLING

(71) Applicant: DANA TM4 INC., BOUCHERVILLE (CA)

(72) Inventors: Carl TRUDEL, Boucherville (CA); Rafaël BÉDARD, Otterburn Park (CA); Francois DESROCHERS, St-Bruno (CA); Benoit BLANCHARD ST-JACQUES, Boucherville (CA)

(21) Appl. No.: 19/435,412

(22) Filed: Dec. 29, 2025

Related U.S. Application Data
(60) Provisional application No. 63/740,637, filed on Dec. 31, 2024.

(51) Int. Cl. H02K 5/10

(52) U.S. Cl. CPC H02K 5/10

(57) ABSTRACT

Systems are provided for stator immersion cooling. In one example approach, an assembly is provided that comprises a stator core; a housing; and a sleeve positioned and compressed between the stator core and the housing, where the sleeve comprises an elastomeric seal positioned along an outer diameter of the sleeve, the elastomeric seal comprising a lip that abuts a side of the stator core.

### CROSS REFERENCE TO RELATED APPLICATIONS

The present application claims priority to U.S. Provisional Application No. 63/740,637, entitled “COMPRESSION SEALING FOR STATOR COOLING”, and filed on Dec. 31, 2024. The entire contents of the above-listed application are hereby incorporated by reference for all purposes.

### TECHNICAL FIELD

The present disclosure relates to electric motor stator cooling systems.

### BACKGROUND AND SUMMARY

A stator is a stationary component that may be found in electric motors and generators. A stator may comprise a laminated stator core and coils of insulated wire called stator windings. When an alternating current is applied to a stator, it may create a rotating magnetic field. Stators may be the stationary part of a rotary system found in electric generators, electric motors, sirens, mud motors, and the like. Energy may flow through a stator to or from a rotating component of the system, the rotor. In an electric motor, a stator may provide a magnetic field that may drive a rotating armature. In a generator, a stator may convert a rotating magnetic field to electric current. In fluid powered devices, a stator may guide a flow of fluid to or from a rotating part of the system. Stators may be included in electric motors in electric vehicle (EV) and hybrid electric vehicle (HEV) motor applications, for example.

The inventors herein have recognized that in electric vehicle (EV) and hybrid electric vehicle (HEV) motor applications, stator winding cooling may increase motor efficiency. For example, cooling efficiency targets may use a flow of oil across the stator, in some examples, to provide cooling to components of a motor. However, the inventors herein have recognized that in some cooling system designs, oil or other coolant fluids may be directed through interior cavities from which the fluid can leak into an air gap between the rotor and the stator. Oil in the air gap may result in drag losses which may in turn result in a significant decrease in motor efficiency, for example.

In order to address these and other issues, in one example approach an assembly is provided that comprises a stator core; a housing; and a sleeve positioned and compressed between the stator core and the housing, where the sleeve comprises an elastomeric seal positioned along an outer diameter of the sleeve, the elastomeric seal comprising a lip that abuts a side of the stator core.

Such an approach may simplify the sealing system to reduce potential failure modes as well as increase efficiency of the cooling system. Further, such an approach may allow for a substantially constant axial force to compress the sleeve onto the stator core over a wide range of temperatures and manufacturing tolerances. In such an approach, compression sleeves may be assembled on each side of a stator core and compressed by the means of a wave spring, or other suitable spring, between the sleeve and the housing on each end of the stator core thereby forming a sealed stator cavity, for example.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an electric motor, including a rotor assembly comprising a rotor core and a rotor shaft in accordance with the present disclosure.

FIG. 2 shows a cross-sectional perspective view of an electric motor cooling system in accordance with the disclosure.

FIGS. 3-5 shows cross-sectional views of an interface between an example compression sleeve and a stator core, in accordance with the disclosure.

FIG. 6 shows an example motor system with baffles for directing coolant between stator windings.

### DETAILED DESCRIPTION

The following description relates to systems for cooling components of an electric motor using compression sleeves positioned along a stator core to direct a suitable coolant fluid, such as oil or some other suitable dielectric fluid, around the stator and stator windings.

As remarked above, the inventors herein have recognized that in electric vehicle (EV) and hybrid electric vehicle (HEV) motor applications, stator winding cooling may increase motor efficiency. For example, cooling efficiency targets may use a flow of oil across the stator, in some examples, to provide cooling to components of a motor. However, the inventors herein have recognized that in some cooling system designs, oil or other coolant fluids may be directed through interior cavities from which the fluid can leak into an air gap between the rotor and the stator. Oil in the air gap may result in drag losses which may in turn result in a significant decrease in motor efficiency, for example.

In particular, the inventors herein have recognized that sealing of a stator may be desirable for immersion cooling, so that the flowing dielectric cooling fluid may not pass into the rotor cavity and create undesired churning losses, for example. For EV motor applications, cooling of the stator windings may be used to maintain targeted performance and efficiencies by increasing the power and torque density, for example. A flow of dielectric fluid, such as oil or some other suitable fluid, across the stator may be used to meet power and torque targets in some examples. In order to achieve this, the stator may be substantially sealed, as described herein, so that the flowing dielectric cooling fluid may not able to pass into the rotor cavity and create undesired churning losses, for example.

In order to address these and other issues, in one example approach described in more detail below, an assembly is provided that comprises a stator core; a housing; and a sleeve positioned and compressed between the stator core and the housing, where the sleeve comprises an elastomeric seal positioned along an outer diameter of the sleeve, the elastomeric seal comprising a lip that abuts a side of the stator core.

Such an approach may simplify the sealing system to reduce potential failure modes as well as increase efficiency of the cooling system. Further, in some examples, such an approach may not use any adhesives at the interfaces of the compression sleeves and the stator. Further, such an approach may allow for a substantially constant axial force to compress the sleeve onto the stator core over a wide range of temperatures and manufacturing tolerances. In such an approach, compression sleeves may be assembled on each side of a stator core and compressed by the means of a wave spring, or other suitable spring, between the sleeve and the housing on each end of the stator core thereby forming a sealed stator cavity, for example.

In the approaches described herein, the sleeve seal support feature and the seal design may be made such that an “as assembled” state offers an initial seal compression sufficient to maintain sealing of the stator cavity. Furthermore, a hard stop from the seal support feature may ensure that the seal may not substantially deform over the support and may reduce seal extrusion into the rotor cavity. The same design feature may allow the seal to deform under cooling fluid pressure and increase the seal compression onto the stator core and may maximize the sealing capability over an operational pressure range.

In some examples, the approaches described herein may be used in combination with other cooling approaches and systems. For example, the approaches described herein may be combined with a conventional water and or ethylene glycol (WEG) cooling jacket to maximize cooling on longer active length motors, for example.

It is to be understood that the specific assemblies and systems illustrated in the attached drawings, and described in the following specification are exemplary embodiments of the inventive concepts defined herein. For purposes of discussion, the drawings are described collectively. Thus, like elements may be commonly referred to herein with like reference numerals and may not be re-introduced.

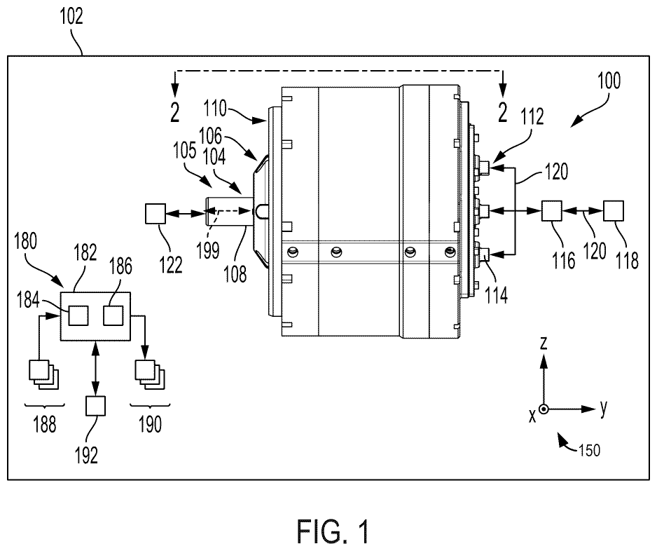

Turning to the figures, FIG. 1 shows an illustration of an electric motor 100. In some examples, the electric motor 100 may be designed as an electric motor-generator and may be included in a system 102 which may take a variety of forms. For instance, the electric motor 100 may be incorporated into an electric drive system of an electric vehicle (EV), in one example. As such, the electric motor may be a traction motor in such an example and the electric drive may further include a transmission (e.g., gearbox), for instance. In the EV example, the EV may be an all-electric vehicle (e.g., a battery electric vehicle (BEV)), in one example, or a hybrid electric vehicle (HEV) with an internal combustion engine, in another example. However, the motor may be used in other suitable systems (e.g., stationary systems), in other examples, such as in industrial machines, agricultural systems, mining systems, and the like.

The electric motor 100 includes a rotor 104 that electromagnetically interacts with a stator 106 to drive rotation of a rotor shaft 108 that is included in the rotor. The electric motor 100 in the illustrated example includes a housing 110 with an electrical interface 112 for the stator 106. The electrical interface 112 may be a multi-phase electrical interface with multiple electrical connectors 114. The electrical interface 112 is shown as a three-phase interface in the illustrated example, but it should be understood that any suitable interface is contemplated, such as two-phase interface, four-phase interface, six-phase interface, nine-phase interface, etc. More generally, in some examples the electric motor 100 may be a multi-phase alternating current (AC) machine. However, in other examples, the electric motor 100 may be a direct current (DC) machine.

As illustrated in FIG. 1, the electric motor 100 may be electrically coupled to an inverter 116. The inverter 116 may be configured to convert direct current (DC) power to alternating current (AC) power. Alternatively, the inverter 116 may be configured to convert AC power to DC power. As such, the electric motor 100 may be an AC electric motor, as indicated above. However, in other examples, the electric motor 100 may be a DC electric motor (as previously indicated) and the inverter 116 may therefore be omitted from the system 102 in some examples. The inverter 116 may receive electric energy from one or more energy storage device(s) 118 (e.g., traction batteries, capacitors, combinations thereof, and the like). Arrows 120 signify electric energy transfers between the electric motor 100, the inverter 116, and the energy storage device(s) 118 that may occur during different modes of system operation.

The system 102 may additionally include a control sub-system 180 with a controller 182. The controller 182 includes a processor 184 and memory 186. The memory 186 may hold instructions stored therein that when executed by the processor 184 cause the controller 182 to perform the various methods, control techniques, and the like, described herein. The processor 184 may include a microprocessor unit and/or other types of circuits. The memory 186 may include known data storage mediums such as random access memory, read-only memory, keep alive memory, combinations thereof, and the like.

The controller 182 may receive various signals from sensors 188 positioned in different locations in the system 102. The sensors 188 may include an electric machine speed sensor, energy storage device temperature sensor(s), one or more energy storage device state of charge sensor(s), an inverter power sensor, and the like. The controller 182 may also send control signals to various actuators 190 coupled at different locations in the system 102. For instance, the controller may send signals to the inverter 116 to adjust the rotational speed of the electric motor 100. In another example, the controller 182 may send a command signal to the electric motor 100 and/or the inverter 116 and in response motor speed may be adjusted. The other controllable components in the system 102 may function in a similar manner with regard to command signals and actuator adjustment.

The system 102 may also include one or more input device(s) 192 (e.g., an accelerator pedal, a brake pedal, a console instrument panel, a touch interface, a touch panel, a keyboard, combinations thereof, and the like). The input device(s) 192, responsive to user input, may generate a motor speed adjustment request, for example.

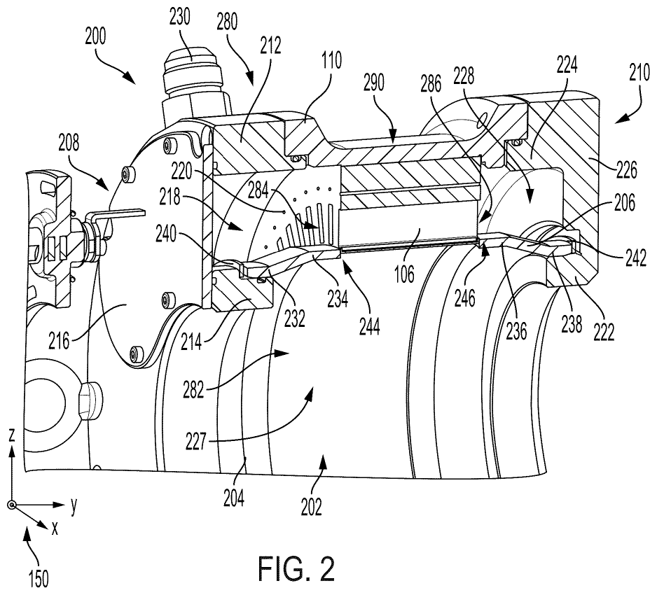

An axis system 150 is provided in the figures for reference. The z-axis may be a vertical axis (e.g., parallel to a gravitational axis), the x-axis may be a lateral axis (e.g., horizontal axis), and/or the y-axis may be a longitudinal axis, in one example. However, the axes may have other orientations, in other examples. Rotational axis 199 of the electric motor 100 is further provided for reference in FIG. 1. A cutting plane 2-2 for the cross-sectional view depicted in FIG. 2 is provided in FIG. 1. The cutting plane 2-2 extends through the motor's rotational axis.

FIG. 2 shows a cross-sectional perspective view of the electric motor 100 and the cooling system 200 for the motor. In FIG. 2, the stator 106 of the electric motor 100 is shown as well as a portion of housing 110 that at least partially encloses the rotor and the stator.

FIG. 2 shows an assembly 280 that may be used to cool at least some components of electric motor 100. For example, assembly 280 may comprise an electric motor system. In some examples, the assembly 280 shown in FIG. 2 may be used to provide cooling to components of an electric motor in an electric or hybrid electric vehicle. However, it is contemplated that assembly 280 may be used to provide cooling to any suitable rotor/stator system.

Assembly 280 comprises a stator 106 with a stator core 282. The stator core may be a hollow orifice within the stator configured to receive and contain a rotor, for example. The stator and stator core may comprise laminations, e.g., they may be formed by layers of metal laminated together at different thicknesses. Lamination may comprise thin sheets of metal usually bonded, welded, or stacked together to form several durable layers, for example. Laminations may be provided at different thicknesses at different locations in the stator and may reduce eddy current losses because they use multiple individual metal pieces instead of one solid metal piece, for example.

Assembly 280 further comprises a housing 110. The housing 110 may be formed in different sections that are coupled to one another, in one example. For instance, a crown side section 208 and a weld side section 210 may be coupled to a housing body 290. The housing body 290 may circumferentially enclose the stator 106 and other components and features of cooling system 200 described herein. Fasteners and/or other suitable attachment devices may be used to attach the crown side section 208 and/or the weld side section 210 to the housing body 290.

Assembly 280 further comprises at least one sleeve (e.g., sleeve 204 or sleeve 206) that is positioned and compressed between the stator core 282 and the housing 110. In some examples, as shown in FIG. 2, the assembly 280 may comprise a first compression sleeve 204 compressed between a first side (e.g., crown side) 208 of the housing 110 and a first side 284 of the stator core 282 and a second compression sleeve 206 compressed between a second side (e.g., weld side) 210 of the housing 110 and a second side 286 of the stator core 282. The second side 286 of the stator core 282 may oppose the first side 284 of the stator core 282, i.e., second side 286 may be on an opposite side of stator core 282 from first side 284.

Each sleeve may form a cavity between the stator core and the housing, where the cavity is substantially fluidically sealed off from a rotor cavity in the stator core. As used herein, the phrase “fluidically sealed off” is intended to mean that substantially no fluid may exit the cavity and go into the rotor cavity so that the cavity is a substantially separate compartment from the rotor cavity. For example, as shown in FIG. 2, housing 110 comprises an interior radial surface 214, an exterior radial surface 212 and an end surface 216 all of which are positioned on first side 284 of the stator core 282 and such that when combined with compression sleeve 204 form a cavity 218 where coolant can flow. Likewise housing 110 comprises an interior radial surface 222, an exterior radial surface 224 and an end surface 226 all of which are positioned on second side 286 of the stator core 282 and such that when combined with compression sleeve 206 form a cavity 228 where coolant can flow.

The cavities formed by the compression sleeve may also contain stator windings (not shown in FIG. 2). For example, cavity 218 shown in FIG. 2 may enclose stator end windings at 220 so that the stator end windings are disposed in the cavity. In this way, when coolant flows through the cavity, it may reduce temperature of the end windings during operation.

The cooling system 200 may further comprise various inlets and outlets for directing a coolant fluid, e.g., a dielectric fluid such as oil or the like, through the passages/cavities in the cooling system. For example, an inlet 230 is shown in FIG. 2. The cooling system 200 may include a pump (not shown) and a filter (not shown) for delivering a coolant, e.g., oil such as a natural and/or synthetic oil and/or some other suitable dielectric fluid, into or around components of stator 106. The sealed cavities, e.g., cavity 218 and 228, formed by the compression sleeves (e.g., sleeve 204 and 206) may receive and/or deliver coolant around components of stator core 282. The sealed cavities 218 and 228 may be fluidly separated from rotor cavity 227 (where the rotor is contained and configured to spin). In this way, coolant may be substantially prevented from entering an air gap in the rotor cavity so that drag losses in the motor may be reduced, thereby increasing motor efficiency, for example.

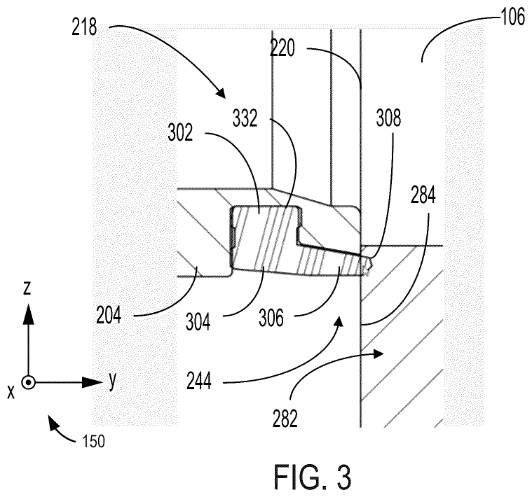

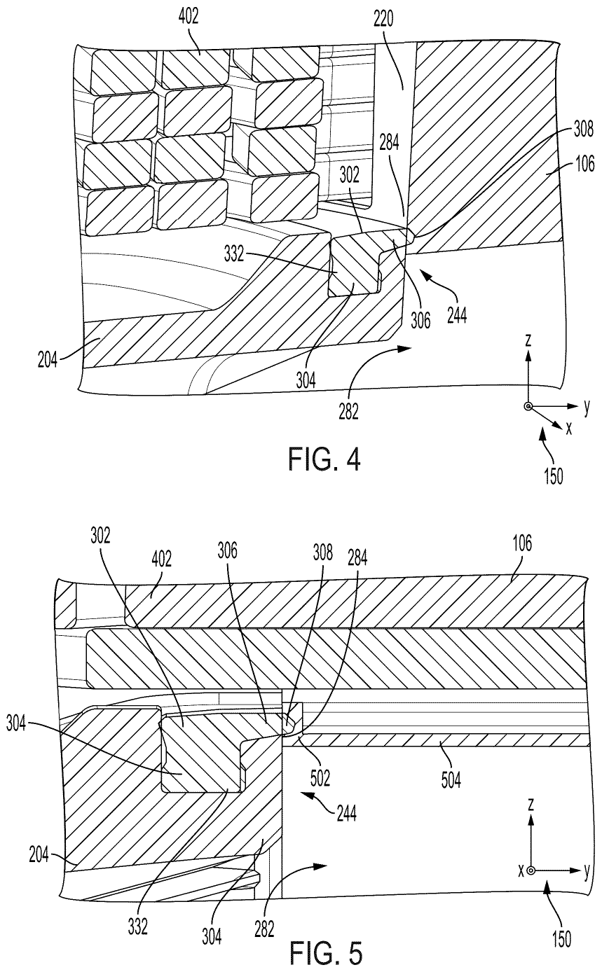

The sleeves (e.g., sleeve 204 and sleeve 206) may be compressed between the stator core 282 and the housing 110 via a spring positioned along an outer diameter of the sleeve opposite an elastomeric seal that is located on an edge of the sleeve at an interface between the sleeve and the stator core. In some examples, the spring may be positioned opposite of a face of the elastomeric seal since the spring may be positioned anywhere on the sleeve with features allowing compression force on the seal. In particular, as shown in FIG. 2, sleeve 204 comprises an elastomeric seal at an interface 244 between the sleeve 204 and the first side 284 of stator core 282 and a spring 240 may be located at an edge of sleeve 204 opposite the edge of sleeve 204 where the seal is at the interface 244; and sleeve 206 comprises an elastomeric seal at an interface 226 between sleeve 206 and the second side 286 of stator core 282 and a spring 242 may be located at an edge of sleeve 206 opposite the edge of sleeve 206 where the seal is at the interface 246. The elastomeric seals at interfaces 244 and 246 are illustrated and described in more detail below with references to FIGS. 3-5.

The springs, e.g., spring 240 and 242, may comprise wave springs or the like in some examples. In other examples, the springs may comprise Belleville washers or the like. Wave springs, also known as coiled wave springs or scrowave springs, are springs made up of pre-hardened flat wire in a process called on-edge coiling (also known as edge-winding). The number of turns and waves can be adjusted to accommodate stronger force or meet specific target spring forces. The wave springs that may be used to compress the sleeves may comprise single turn wave springs, or multi-turn wave springs, or nested wave springs or the like.

As remarked above, in other examples, the springs compressing the sleeves may comprise Belleville washers, also known as a coned-disc springs, conical spring washers or disc springs. A Belleville washer is a type of spring shaped like a washer and may be used in some examples to compress one or more sleeves in the cooling system. Other types of springs may be used to provide a compression force. For example, any suitable pre-loading spring mechanisms such as an oil-pressure driven preload or a spring embedded in the sleeve, for example.

In some examples, the springs compressing the sleeves, e.g., the wave springs, may have a nominal compressive force of approximately 467 N (approx. 110 lbf), or may be in a range of about 400 to 500 N. However, other compressive forces are contemplated.

The compression sleeves may have an angled shape to fit between the housing and the stator core. For example, first compression sleeve 204 may have a first bend 232 and second bend 234, where the second bend 234 is positioned on the sleeve 204 on stator side. Likewise, the second compression sleeve 206 may have a first bend 238 and second bend 236 where the second bend 236 is positioned on sleeve 206 on stator side. The bends in the sleeves may extend radially around the sleeve and may be such that the housing side of the sleeves is lower (along the z-axis) than the stator side of the sleeve.

These springs that compress the sleeves may allow for a substantially constant axial force to compress the sleeve onto the stator core over a wide range of temperatures and manufacturing tolerances. In such an approach, compression sleeves may be assembled on each side of a stator core and compressed by the means of a wave spring, or other suitable spring, between the sleeve and the housing on each end of the stator core thereby forming a sealed stator cavity, for example. The sleeve seal support feature and the seal design may be made such that an “as assembled” state offers an initial seal compression sufficient to maintain sealing of the stator cavity. Furthermore, a hard stop from the seal support feature (described in more detail below) may ensure that the seal may not substantially deform over the support and may reduce seal extrusion into the rotor cavity. The same design feature may allow the seal to deform under cooling fluid pressure and increase the seal compression onto the stator core and may maximize the sealing capability over an operational pressure range.

FIGS. 3-5 shows cross-sectional detailed views of an interface, e.g., interface 244, between an example compression sleeve 204 and a stator core 282. As remarked above, each sleeve, e.g., sleeve 204 and 206, may comprise an elastomeric seal positioned along an outer diameter of the sleeve at an edge of the sleeve on the stator side. For example, as shown in FIGS. 3-5, sleeve 204 comprises an elastomeric seal 302 that presses against a side 284 of stator core 282.

In some examples, the sleeve 204 may comprise a groove 332 along an outer diameter of the sleeve (on the stator side of the sleeve) and the elastomeric seal 302 may be positioned in the groove. The seal 302 may be molded as an integral part of the sleeve in some examples. However, in other examples, the seal 302 may be inserted and maintained in the groove 332 via an interference fit or adhesive or the like.

The elastomeric seal may comprise a lip 306 that abuts a side of the stator core. In particular, the seal 302 may have a thicker end 304 and a thinner end 306 with a tip that fits into a seal lip support indentation 308 in the stator core 282 that is configured to receive and secure an end of the lip. As remarked above, the stator core comprises laminations and laminations on the stator core around the seal lip indentation 308 may have a thickness in a range of about 0.5 mm to 2 mm, however other thicknesses are contemplated. In some examples, the stator lamination core may have a hybrid lamination design that optimizes the seal contact surface between the stator core 282 and the seal 302. For example, as shown in FIG. 5, a region 502 near seal 302 on the sleeve may comprise thicker laminations than a region 504 of the stator core 282 positioned above the stator cavity 244.

The seal 302 may be comprised of any suitable material and in some examples may have approximately 3% stretch when assembled and a 10% nominal squeeze through the sealing lip. The material of the seal may be selected to achieve target squeeze, process, fluid compatibility, and application temperature to meet predetermined target. Examples of materials that may be used include HNBR, NBR, Viton, Nytrill, ACM, etc.

In some examples, baffles surrounding stator end windings in a cavity formed by the sleeve between the stator core and the housing may be included. Such baffles may be configured to direct flow of a dielectric fluid between the stator end windings in the cavity. In some examples, the sealing sleeve can be designed to include a baffle surrounding the heads to force the oil flow between the winging and maximize the cooling performance of the middle leads.

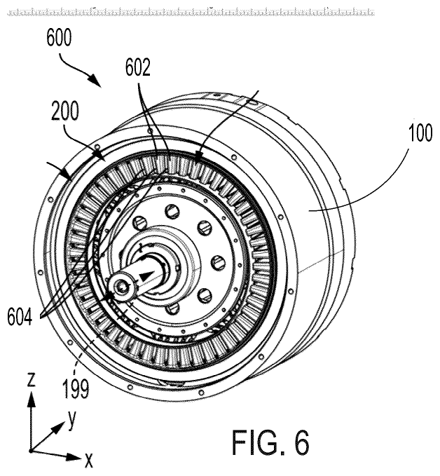

For example, FIG. 6 shows an example motor system 600 with baffles 602 for directing coolant between stator end windings. In particular, FIG. 6 shows a view of a crown side of the electric motor 100 and the cooling system 200 with the sealing sleeve omitted to reveal baffles 602 around the stator windings. In the illustrated example, baffles 402 with channels 404 therebetween are included around the stator windings. The baffles may be part of the sleeve or formed as a separate structure from the sleeve. When the baffles are formed as a separate structure they may be attached to the compression sleeve via mechanical and/or chemical attachment techniques such as welding (e.g., vibration welding, laser welding, and the like), single piece molding, adhesive bonding, combinations thereof, and the like.

The baffles 602 may be contoured to enable the channels 604 to receive coolant from the coolant cavity, e.g., cavity 218, depicted in FIG. 2, and to direct coolant towards and through the end windings of the stator. In this way, the end windings may be more effectively cooled. The baffles 602 may be further profiled to allow the end windings to pass therethrough. The baffles 602 may be radially aligned and/or may be symmetrically spaced at predetermined angles around the ring. The channels 604 between the baffles 602 may extend in radial directions and may be aligned with the stator such that coolant can pass through the channels 604 and be direct towards the end windings. The channels 604 may have a rectangular cross-sectional contour, in one example. However, other channel profiles are contemplated.

FIGS. 1-6 are drawn approximately to scale, aside from the schematically depicted components. However, the components may have other relative dimensions, in other embodiments. The figures show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such. Even further, elements which are coaxial or parallel to one another may be referred to as such.

The invention will be further described in the following paragraphs. In one aspect, an assembly is provided that comprises a stator core; a housing; and a sleeve positioned and compressed between the stator core and the housing, where the sleeve comprises an elastomeric seal positioned along an outer diameter of the sleeve, the elastomeric seal comprising a lip that abuts a side of the stator core. In some examples, the sleeve may comprise a groove along an outer diameter of the sleeve; wherein the elastomeric seal is positioned in the groove. In another aspect, the stator core may comprise a seal lip support indentation configured to receive and secure an end of the lip. In some examples, the stator core may comprise laminations and laminations on the stator core around the seal lip indentation may have a minimum thickness in a range of about 0.5 mm to 2 mm, for example. In some aspects, the sleeve may comprise a first sleeve compressed between a first side of the housing and a first side of the stator core and a second sleeve compressed between a second side of the housing and a second side of the stator core. In some examples, the second side of the stator core may oppose the first side of the stator core. In some aspects, the first sleeve may comprise a first elastomeric seal positioned along an outer diameter of the first sleeve, where the first elastomeric seal comprises a first lip that abuts the first side of the stator core; and wherein the second sleeve comprises a second elastomeric seal positioned along an outer diameter of the second sleeve, where the second elastomeric seal comprises a second lip that abuts the second side of the stator core. In some examples, the sleeve may form a cavity between the stator core and the housing, where the cavity is substantially fluidically sealed off from a rotor cavity in the stator core. In some examples, an inlet and an outlet may be included in the cavity and may be configured to direct a dielectric fluid through the cavity. In some examples, stator end windings may be disposed in the cavity. In some aspects, the sleeve may be compressed between the stator core and the housing via a spring positioned along an outer diameter of the sleeve opposite the elastomeric seal. In some examples, the spring may comprise a wave spring or the like. In other examples, the spring may comprise a Belleville washer or the like. In some aspects, baffles surrounding stator end windings may be included in a cavity formed by the sleeve between the stator core and the housing, where the baffles are configured to direct flow of a dielectric fluid between the stator end windings in the cavity.

In another aspect, an electric motor cooling system is provided that comprises a stator core; a housing; a sleeve positioned and compressed between the stator core and the housing, where the sleeve comprises an elastomeric seal positioned along an outer diameter of the sleeve, the elastomeric seal comprising a lip that abuts a side of the stator core; and wherein the sleeve is compressed between the stator core and the housing via a spring positioned along an outer diameter of the sleeve opposite the elastomeric seal. In some examples, the stator core may comprise a seal lip support indentation configured to receive and secure an end of the lip; and wherein laminations on the stator core around the seal lip indentation have a minimum thickness in a range of about 0.5 mm to 2 mm. In some examples, the sleeve may form a cavity between the stator core and the housing, where the cavity is substantially fluidically sealed off from a rotor cavity in the stator core; and wherein the electric motor cooling system further comprises an inlet and an outlet in the cavity configured to direct a dielectric fluid through the cavity, wherein stator end windings are disposed in the cavity.

In another aspect, an electric motor cooling system for an electric or hybrid electric vehicle is provided that comprises a stator core; a housing; a first sleeve compressed between a first side of the housing and a first side of the stator core and a second sleeve compressed between a second side of the housing and a second side of the stator core, where the second side of the stator core opposes the first side of the stator core; wherein the first sleeve comprises a first elastomeric seal positioned along an outer diameter of the first sleeve, where the first elastomeric seal comprises a first lip that abuts the first side of the stator core; and wherein the second sleeve comprises a second elastomeric seal positioned along an outer diameter of the second sleeve, where the second elastomeric seal comprises a second lip that abuts the second side of the stator core. In some examples, the first sleeve may be compressed between the first side of the stator core and the first side of the housing via a first spring positioned along an outer diameter of the first sleeve opposite the first elastomeric seal; and wherein the second sleeve is compressed between the second side of the stator core and the second side of the housing via a second spring positioned along an outer diameter of the second sleeve opposite the second elastomeric seal. In some examples, the first and second springs may comprise wave springs.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An assembly comprising:
a stator core;
a housing;
a sleeve positioned and compressed between the stator core and the housing, where the sleeve comprises an elastomeric seal positioned along an outer diameter of the sleeve, the elastomeric seal comprising a lip that abuts a side of the stator core.

2. The assembly of claim 1, wherein the sleeve comprises a groove along an outer diameter of the sleeve; and wherein the elastomeric seal is positioned in the groove.

3. The assembly of claim 1, wherein the stator core comprises a seal lip support indentation configured to receive and secure an end of the lip.

4. The assembly of claim 3, wherein the stator core comprises laminations and laminations on the stator core around the seal lip indentation have a minimum thickness in a range of about 0.5 mm to 2 mm.

5. The assembly of claim 1, wherein the sleeve comprises a first sleeve compressed between a first side of the housing and a first side of the stator core and a second sleeve compressed between a second side of the housing and a second side of the stator core.

6. The assembly of claim 5, wherein the second side of the stator core opposes the first side of the stator core.

7. The assembly of claim 5, wherein the first sleeve comprises a first elastomeric seal positioned along an outer diameter of the first sleeve, where the first elastomeric seal comprises a first lip that abuts the first side of the stator core; and wherein the second sleeve comprises a second elastomeric seal positioned along an outer diameter of the second sleeve, where the second elastomeric seal comprises a second lip that abuts the second side of the stator core.

8. The assembly of claim 1, wherein the sleeve forms a cavity between the stator core and the housing, where the cavity is substantially fluidically sealed off from a rotor cavity in the stator core.

9. The assembly of claim 8, further comprising an inlet and an outlet in the cavity configured to direct a dielectric fluid through the cavity.

10. The assembly of claim 8, wherein stator end windings are disposed in the cavity.

11. The assembly of claim 1, wherein the sleeve is compressed between the stator core and the housing via a spring positioned opposite a face of the elastomeric seal.

12. The assembly of claim 11, wherein the spring comprises a wave spring.

13. The assembly of claim 11, wherein the spring comprises a Belleville washer.

14. The assembly of claim 1, further comprising baffles surrounding stator end windings in a cavity formed by the sleeve between the stator core and the housing, where the baffles are configured to direct flow of a dielectric fluid between the stator end windings in the cavity.

15. An electric motor cooling system, comprising:
a stator core;
a housing;
a sleeve positioned and compressed between the stator core and the housing, where the sleeve comprises an elastomeric seal positioned along an outer diameter of the sleeve, the elastomeric seal comprising a lip that abuts a side of the stator core; and
wherein the sleeve is compressed between the stator core and the housing via a spring positioned opposite a face of the elastomeric seal.

16. The electric motor cooling system of claim 15, wherein the stator core comprises a seal lip support indentation configured to receive and secure an end of the lip; and wherein laminations on the stator core around the seal lip indentation have a minimum thickness in a range of about 0.5 mm to 2 mm.

17. The electric motor cooling system of claim 15, wherein the sleeve forms a cavity between the stator core and the housing, where the cavity is substantially fluidically sealed off from a rotor cavity in the stator core; and wherein the electric motor cooling system further comprises an inlet and an outlet in the cavity configured to direct a dielectric fluid through the cavity, wherein stator end windings are disposed in the cavity.

18. An electric motor cooling system for an electric or hybrid electric vehicle, comprising:
a stator core;
a housing;
a first sleeve compressed between a first side of the housing and a first side of the stator core and a second sleeve compressed between a second side of the housing and a second side of the stator core, where the second side of the stator core opposes the first side of the stator core;
wherein the first sleeve comprises a first elastomeric seal positioned along an outer diameter of the first sleeve, where the first elastomeric seal comprises a first lip that abuts the first side of the stator core; and
wherein the second sleeve comprises a second elastomeric seal positioned along an outer diameter of the second sleeve, where the second elastomeric seal comprises a second lip that abuts the second side of the stator core.

19. The electric motor cooling system for an electric or hybrid electric vehicle of claim 18, wherein the first sleeve is compressed between the first side of the stator core and the first side of the housing via a first spring positioned opposite a face of the first elastomeric seal; and
wherein the second sleeve is compressed between the second side of the stator core and the second side of the housing via a second spring positioned opposite a face of the second elastomeric seal.

20. The electric motor cooling system for an electric or hybrid electric vehicle of claim 19, wherein the first and second springs comprise wave springs, Belleville washers or other pre-loading spring mechanisms.
